(19) United States
(12) Patent Application Publication
(10) Pub. No.: US 2004/0164150 A1
(43) Pub. Date: Aug. 26, 2004

(54) Reader for IC mounted magnetic card

(75) Inventor: Hidekazu Mori, Mishima-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Toshiba Tec Kabushiki Kaisha, Tokyo (JP)

(21) Appl. No.: 10/373,932

(22) Filed: Feb. 26, 2003

(51) Int. Cl. G06K 7/00

(52) U.S. Cl. 235/440

(57) ABSTRACT

A magnetic card reader has a transfer section in which a magnetic head and an IC card reading section are arranged. A judging means for judging whether or not the card transferred in the transfer section is a cleaning card for cleaning the IC card contact point of the IC card reading section is arranged in the magnetic card reader.

### BACKGROUND OF THE INVENTION

1. Field of the Invention

The present invention relates to a reader for an IC mounted magnetic card that permits data to be written to and read from a magnetic card or an IC card.

2. Description of the Related Art

It is known to the art that data can be written to and read from a magnetic card or an IC card. FIG. 12 schematically shows the construction of a magnetic card reader 10. The magnetic card reader 10 permits data to be written to and read from a magnetic card 1 shown in FIG. 4A, an IC card 2 shown in FIG. 4B and an IC-added magnetic card 3 shown in FIG. 4C.

The magnetic card reader 10 comprises a transfer section 4 for transferring the magnetic card 1, the IC card 2 and the IC-added magnetic card 3. The magnetic card 1, the IC card 2 and the IC-added magnetic card 3 are collectively called a card 10a hereinafter.

The transfer section 4 includes an insertion port 11 through which the card 10a is inserted into the magnetic card reader 10. Transfer rollers 12 and 13 for transferring the card 10a are arranged in the transfer section 4. The card 10a inserted through the insertion port 11 is transferred within the magnetic card reader 10 in accordance with rotation of the transfer roller 12 so as to be discharged from the magnetic card reader 10 through a discharge port 14.

A magnetic head 15 is arranged between the transfer rollers 12 and 13. The magnetic head 15 permits data to be written to and read from a magnetic tape la of the magnetic card 1 shown in FIG. 4A or a magnetic tape 3a of the IC-added magnetic card 3 shown in FIG. 4C.

An IC card reading section 16 is formed between the transfer roller 13 and the discharge port 14. The IC card reading section 16 includes an IC contact point 17 that is brought into contact with an IC 2b of the IC card 2 shown in FIG. 4B or an IC 3b of the IC-added magnetic card 3 shown in FIG. 4C.

When data is written to or read from the IC 2b of the IC card 2 or the IC 3b of the IC-added magnetic card 3, the IC contact point 17 is moved downward so as to be brought into contact with the IC 2b or the IC 3b.

When a card that does not include the IC 2b or the IC 3b, i.e., the magnetic card 1, is inserted into the magnetic card reader 10, the IC contact point 17 is held in the elevated position.

In the magnetic card reader 10 of the construction described above, it is necessary to clean the magnetic head 10 and the IC contact point 17 in the IC card reading section 16. Where the magnetic head 15 is cleaned, use is made of a cleaning card 21 shown in FIG. 13A, which is used exclusively for cleaning the magnetic head. Likewise, where the IC contact point 17 is cleaned, use is made of a cleaning card 22 shown in FIG. 13B, which is used exclusively for cleaning the IC card. The cleaning card 21 and the cleaning card 22 differ from each other in the surface state.

Where the magnetic head 15 is cleaned, the magnetic head 15 is set in a cleaning mode in a host computer (not shown). As a result, an instruction to clean the magnetic head 15 is output from the host computer (not shown) to the magnetic card reader 10. Then, the operator inserts the cleaning card 21 shown in FIG. 13A, which is used exclusively for cleaning the magnetic head, into the magnetic card reader 10 through the insertion port 11.

The cleaning card 21 for cleaning the magnetic head, which is inserted through the insertion port 11, is transferred within the transfer section 4 and stopped at the position of the magnetic head 15. Then, the cleaning card 21 for cleaning the magnetic head is moved back and forth about the magnetic head 15. As a result, the magnetic head 15 is cleaned. After the cleaning operation is finished, the cleaning card 21 for cleaning the magnetic head is transferred within the transfer section 4 so as to be discharged from the magnetic card reader 10 through the discharge port 14. In this fashion, the cleaning of the magnetic head 15 is finished.

On the other hand, in the case of cleaning the IC contact point 17, a mode for cleaning the IC contact point 17 is set in a host computer (not shown). As a result, an instruction to clean the IC contact point 17 is output from the host computer (not shown) to the magnetic card reader 10. Then, the operator inserts the cleaning card 22 shown in FIG. 13B, which is used exclusively for cleaning the IC card, into the magnetic card reader 10 through the insertion port 11.

The cleaning card 22 for cleaning the IC card, which is inserted through the insertion port 11, is transferred within the transfer section 4 and stopped at the position of the IC contact point 17. Then, the IC contact point 17 is moved downward so as to be brought into contact with the surface of the cleaning card 22 for cleaning the IC card. Under this condition, the cleaning card 22 for cleaning the IC card is moved back and forth about the IC contact point 17 so as to clean the IC contact point 17. Then, the cleaning card 22 for cleaning the IC card is transferred within the transfer section 4 so as to be discharged from the magnetic card reader 10 through the discharge port 14. In this fashion, the cleaning of the IC contact point 17 is finished.

It is possible for an error to take place such that the cleaning card 21 for cleaning the magnetic head is inserted into the magnetic card reader 10 through the insertion port 11 in spite of the situation that a mode to clean the IC contact point 17 is set in the host computer. In this case, the cleaning card 21 for cleaning the magnetic head is transferred within the transfer section 4 and stopped at the position of the IC contact point 17. Then, the IC contact point 17 is moved downward so as to be brought into contact with the cleaning card 21 for cleaning the magnetic head. In this case, the cleaning card 21 for cleaning the magnetic head is moved back and forth about the IC contact point 17. It follows that it is possible for the cleaning card 21 for cleaning the magnetic head to break the IC contact point 17.

### BRIEF SUMMARY OF THE INVENTION

An object of the present invention is to provide a reader for an IC mounted magnetic card which permits preventing the IC contact point from being broken during the cleaning operation.

According to one embodiment of the present invention, there is provided a reader for an IC mounted magnetic card, comprising a transfer section constructed to transfer a magnetic card or an IC card inserted into the reader for an IC mounted magnetic card through an insertion port; a magnetic head for reading the magnetic information recorded on the magnetic card; an IC card reading section constructed to be brought into contact with an IC contact point of the IC card so as to read data recorded in the IC; and judging means for judging the kind of card as to whether the inserted card is a cleaning card for cleaning the IC card contact point.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 shows the construction of a magnetic card reader according to first and second embodiments of the present invention;

FIG. 2A is a plan view showing a cleaning card used exclusively for cleaning a magnetic head;

FIG. 2B is a plan view showing a cleaning card used exclusively for cleaning an IC card;

FIG. 3 is a block diagram showing the system construction of the magnetic card reader;

FIG. 4A is a plan view showing the construction of a magnetic card;

FIG. 4B is a plan view showing the construction of an IC card;

FIG. 4C is a plan view showing the construction of an IC-added magnetic card;

FIG. 5 is a flowchart for explaining the operation of the magnetic card reader according to the first embodiment of the present invention;

FIG. 6 is a flowchart for explaining the operation of the magnetic card reader according to the second embodiment of the present invention;

FIG. 7 shows the construction of a magnetic card reader according to third and fourth embodiments of the present invention;

FIG. 8 is a block diagram showing the system construction of the magnetic card reader shown in FIG. 7;

FIG. 9A is a plan view showing as an example the construction of a cleaning card used exclusively for cleaning an IC card;

FIG. 9B is a plan view showing as another example the construction of a cleaning card used exclusively for cleaning an IC card;

FIG. 10 is a flowchart for explaining the operation of the magnetic card reader according to the third embodiment of the present invention;

FIG. 11 is a flowchart for explaining the operation of the magnetic card reader according to the fourth embodiment of the present invention;

FIG. 12 shows the construction of the conventional magnetic card reader;

FIG. 13A shows the construction of a conventional cleaning card used exclusively for cleaning a magnetic head; and

FIG. 13B shows the construction of a conventional cleaning card used exclusively for cleaning an IC card.

### DETAILED DESCRIPTION OF THE INVENTION

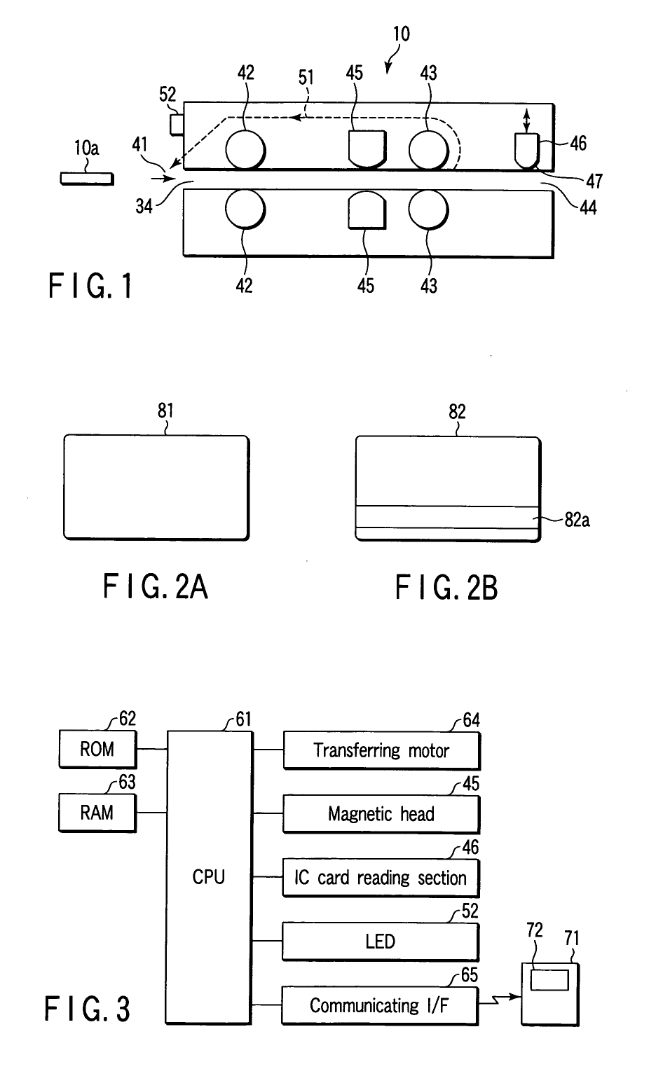

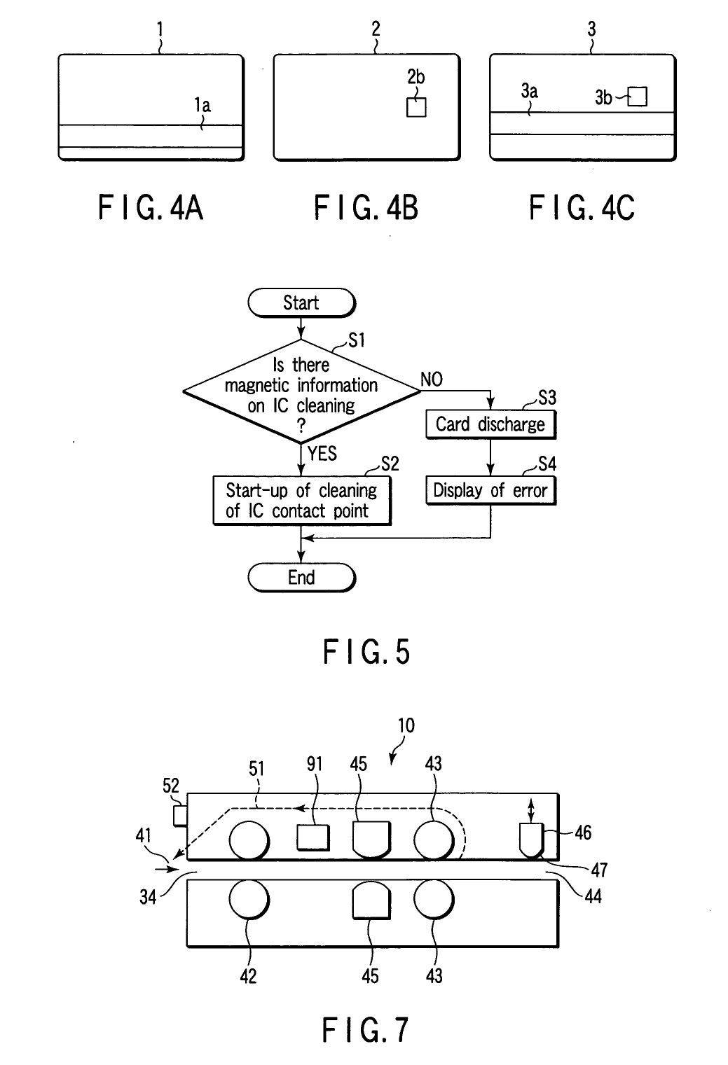

One embodiment of the present invention will now be described with reference to the accompanying drawings. Specifically, FIG. 1 schematically shows the construction of a magnetic card reader 10. The magnetic card reader 10 permits data to be written to and read from the magnetic IC card 1 shown in FIG. 4A, the IC card 2 shown in FIG. 4B and the IC-added magnetic card 3 shown in FIG. 4C.

The magnetic card reader 10 comprises a transfer section 34 for transferring the magnetic card 1, the IC card 2 and the IC-added magnetic card 3. The magnetic card 1, the IC card 2 and the IC-added magnetic card 3 are collectively called a card 10a hereinafter.

The transfer section 34 includes an insertion port 41 through which the card 10a is inserted into the magnetic card reader 10. Also, transfer rollers 42 and 43 are arranged in the transfer section 34. The card 10a inserted into the magnetic card reader 10 through the insertion port 41 is transferred within the transfer section 34 in accordance with rotation of the transfer roller 42 so as to be discharged from the magnetic card reader 10 through a discharge port 44.

As shown in the drawing, a magnetic head 45 is arranged between the transfer rollers 42 and 43. The magnetic head 45 permits data to be written to and read from a magnetic tape la of the magnetic card 1 shown in FIG. 4A or a magnetic tape 3a of the IC-added magnetic card 3 shown in FIG. 4C.

An IC card reading section 46 is formed between the transfer roller 43 and the discharge port 44. The IC card reading section 46 includes an IC contact point 47 that is brought into contact with an IC 2b of the IC card 2 shown in FIG. 4B or an IC 3b of the IC-added magnetic card 3 shown in FIG. 4C.

When data is written to or read from the IC 2b of the IC card 2 or the IC 3b of the IC-added magnetic card 3, the IC contact point is moved downward so as to be brought into contact with the IC 2b or the IC 3b.

It should be noted that the IC contact point 47 is held in the elevated position when a card that does not include the IC 2b or the IC 3b, i.e., the magnetic card 1, is inserted into the magnetic card reader 10.

A return path 51 for returning the card transferred through the transfer roller 43 back to the insertion port 41 is formed between the transfer roller 43 and the IC card reading section 46. A transfer roller (not shown) is arranged for the return path 51.

Further, an LED 52 for emitting an alarm is formed on the front surface of the magnetic card reader 10.

The system construction of the magnetic card reader 10 shown in FIG. 1 will now be described with reference to FIG. 3.

Reference numeral 61 shown in FIG. 3 represents a CPU (Central Processing Unit) for collectively controlling the magnetic card reader 10. Connected to the CPU 61 are a ROM (Read Only Memory) 62, a RAM (Random Access Memory) 63, a transferring motor 64 for rotating the transfer rollers 42, 43, an IC card reading section 46, an LED 52, and a communication interface (I/F) 65. A host computer 71 is connected to the communication interface 65. The host computer 71 includes a key input section (not shown) and a display section 72. A microprocessor is used as the main component of the host computer 71. It is possible to give an instruction for data to be written to and read from the card 10a or to set a mode for cleaning the magnetic head 45 or a mode for cleaning the IC contact point 47 of the magnetic card reader 10 by operating the key input section.

Incidentally, FIG. 2A shows a cleaning card 81 used exclusively for cleaning the magnetic head 45, and FIG. 2B shows a cleaning card 82 used exclusively for cleaning the IC contact point 47. A magnetic tape 82a is formed on the cleaning card 82. A discriminator for discriminating that the cleaning card 82 is a cleaning card used exclusively for cleaning the IC contact point 47 and the number of times “In” of cleaning operations applied to the IC contact point 47 are recorded on the magnetic tape 82a in the form of magnetic information.

The operation of the magnetic card reader according to one embodiment of the present invention, which is constructed as described above, will now be described. Where the magnetic head 45 is cleaned, a mode to clean the magnetic head 45 is set first in the host computer 71. The instruction is transmitted to the magnetic card reader 10. In response to the instruction, the magnetic card reader 10 permits the magnetic head 45 to be operated in a cleaning mode.

When the operator inserts the cleaning card 81 into the magnetic card reader 10 through the insertion port 41, the cleaning card 81 is transferred in the transfer section 34 and is once stopped at the position of the magnetic head 45. Then, the transfer section 34 is controlled to permit the cleaning card 81 to be reciprocated about the magnetic head 45. The reciprocating movement of the cleaning card 81 is carried out a prescribed number of times. As a result, the magnetic head 45 is cleaned. Then, the cleaning card 81 is transferred in the transfer section 34 to reach the discharge port 44 so as to be discharged from the magnetic card reader 10. The cleaning of the magnetic head 45 is finished in this fashion.

Where the IC contact point 47 is cleaned, the IC contact point 47 is set in a cleaning mode in the host computer 71. The instruction is transmitted to the magnetic card reader 10. In response to the instruction, the magnetic card reader 10 is operated in a mode of cleaning the IC contact point 47. To be more specific, the IC contact point 47 is cleaned by the treatments given in the flowchart shown in FIG. 5.

When the operator inserts the cleaning card 82 into the magnetic card reader 10 through the insertion port 41, the cleaning card 82 is transferred in the transfer section 34 and is once stopped at the position of the magnetic head 45. Then, it is judged by the magnetic head 45 whether or not a discriminator, which indicates that the card is a cleaning card used exclusively for cleaning the IC contact point 47, is recorded on the magnetic tape 82a of the cleaning card 82 in the form of magnetic information (step S1).

Where step S1 yields “YES”, the cleaning of the IC contact point 47 is started (step S2). By the processing in step S2, a cleaning section is formed. To be more specific, the cleaning card 82 is transferred in the transfer section 34 to reach the position of the IC card reading section 46. Then, the IC contact point 47 is moved downward in the IC card reading section 46. As a result, the IC contact point 47 is brought into contact with the cleaning card 82. Then, the cleaning card 82 is reciprocated about the IC contact point 47. The reciprocating movement of the cleaning card 82 is carried out a prescribed number of times, thereby cleaning the IC contact point 47. Then, the cleaning card 82 is transferred in the transfer section 34 to reach the discharge port 44 so as to be discharged from the magnetic card reader 10. The cleaning of the IC contact point 47 is finished in this fashion.

On the other hand, where step S1 yields “NO”, it is judged that a card differing from the cleaning card 82 has been inserted into the magnetic card reader 10. In this case, the card inserted into the magnetic card reader 10 is returned from the position of the magnetic head 45 back to the insertion port 41 through the return path 51 so as to be discharged from the magnetic card reader 10 through the insertion port 11 (step 3).

Then, the LED 52 is lit. As a result, the operator is informed that a card other than the cleaning card 82 has been erroneously inserted into the magnetic card reader 10 in spite of the situation that a mode for cleaning the IC contact point 47 has been set. In other words, an error is displayed (step S4). Incidentally, it is possible to display the error on the display section 72 of the host computer 71 in place of lighting the LED 52.

As described above, in the case of cleaning the IC contact point 47, it is possible to prevent the IC contact point 47 from being broken by cleaning with a cleaning card other than the cleaning card 82 used exclusively for cleaning the IC contact point 47.

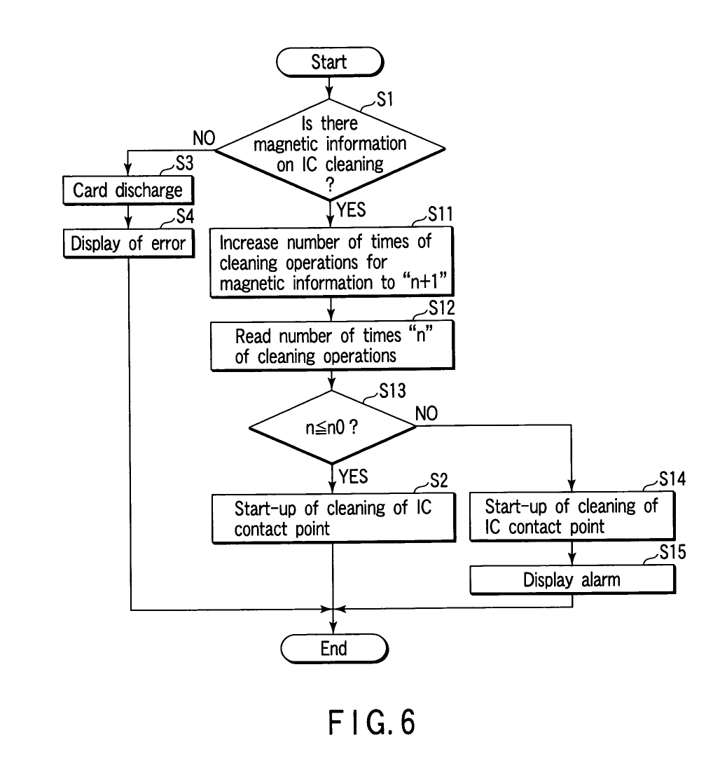

A second embodiment of the present invention will now be described with reference to the flowchart shown in FIG. 6. Incidentally, in the flowchart shown in FIG. 6, the same reference numerals are applied to those portions which are equivalent to the portions shown in the flowchart of FIG. 5.

In the case of cleaning the IC contact point 47, a mode for cleaning the IC contact point 47 is set in the host computer 71. The instruction is transmitted to the magnetic card reader 10. In response to the instruction, the magnetic card reader 10 is operated in the mode of cleaning the IC contact point 47. In other words, the processing for cleaning the IC contact point 47 is carried out by the treatments given in the flowchart shown in FIG. 6.

When the operator inserts the cleaning card 82 into the magnetic card reader 10 through the insertion port 41, the cleaning card 82 is transferred in the transfer section 34 and is once stopped at the position of the magnetic head 45. Then, it is judged by the magnetic head 45 whether or not a discriminator, which indicates that the card inserted into the magnetic card reader 10 is the cleaning card used exclusively for cleaning the IC contact point 47, is recorded on the magnetic tape 82a of the cleaning card 82 in the form of magnetic information (step S1).

Where step S1 described above yields “YES”, the number of times “n” of cleaning operations recorded on the magnetic tape 82a of the cleaning card 82 is increased to “n+1” (step S11). Then, the number of times “n” of cleaning operations is read by the CPU 61 (step S12), and it is judged whether or not the number of times “n” of cleaning operations is less than or equal to a specified number of times “no” (step S13). Incidentally, “no” noted above represents the life of the cleaning card 82 in terms of the number of times of cleaning operations performed by using the cleaning card 82.

Where step S13 yields “YES”, the cleaning of the IC contact point 47 is started (step S2). This process is equivalent to the process in step S2 included in the flowchart shown in FIG. 5.

On the other hand, where step S13 yields “NO”, the cleaning of the IC contact point 47 is started (step S14). The processing in step S14 is equivalent to the processing in step S2 described above and, thus, the detailed description of the processing in step S14 is omitted. Then, the LED 52 is made to flicker so as to give the operator an alarm that the life of the cleaning card 82 used exclusively for cleaning the IC contact point 17 has been reached.

On the other hand, where step S1 yields “NO”, the card is discharged (step S3) and an error is displayed (step S4). The processing in steps S3 and S4 is equivalent to the processing in steps S3 and S4 included in the flowchart shown in FIG. 5 and, thus, the detailed description of steps S3 and S4 is omitted.

As described above, in the case of cleaning the IC contact point 47, it is possible to prevent the IC contact point 47 from being broken by cleaning with a cleaning card other than the cleaning card 82 used exclusively for cleaning the IC contact point 47. Further, it is possible for the operator to know the time of replacing the cleaning card 82.

A third embodiment of the present invention will now be described with reference to FIGS. 7 to 10.

The construction of the magnetic card reader 10 will be described first with reference to FIG. 7. In each of the first and second embodiments described above, a discriminator, which indicates that the card inserted into the magnetic card reader 10 is the cleaning card used exclusively for cleaning the IC contact point 47, is recorded on the magnetic tape 82a of the cleaning card 82. In the third embodiment of the present invention, however, an expression “For IC Only” is printed on the surface of a cleaning card 100 as shown in FIG. 9A. In other words, in the third embodiment of the present invention, the expression “For IC Only” is read by a scanner 91 so as to detect that the card inserted into the magnetic card reader 10 is the cleaning card 82 used exclusively for cleaning the IC contact point 47.

In the magnetic card reader 10 shown in FIG. 7, those portions which are equivalent to the portions shown in FIG. 1 are denoted by the same reference numerals so as to avoid the detailed description thereof.

What should be noted is that the reference numeral 91 shown in FIG. 7 represents a scanner. The scanner 91 takes in the image of the card transferred in the transfer section 34.

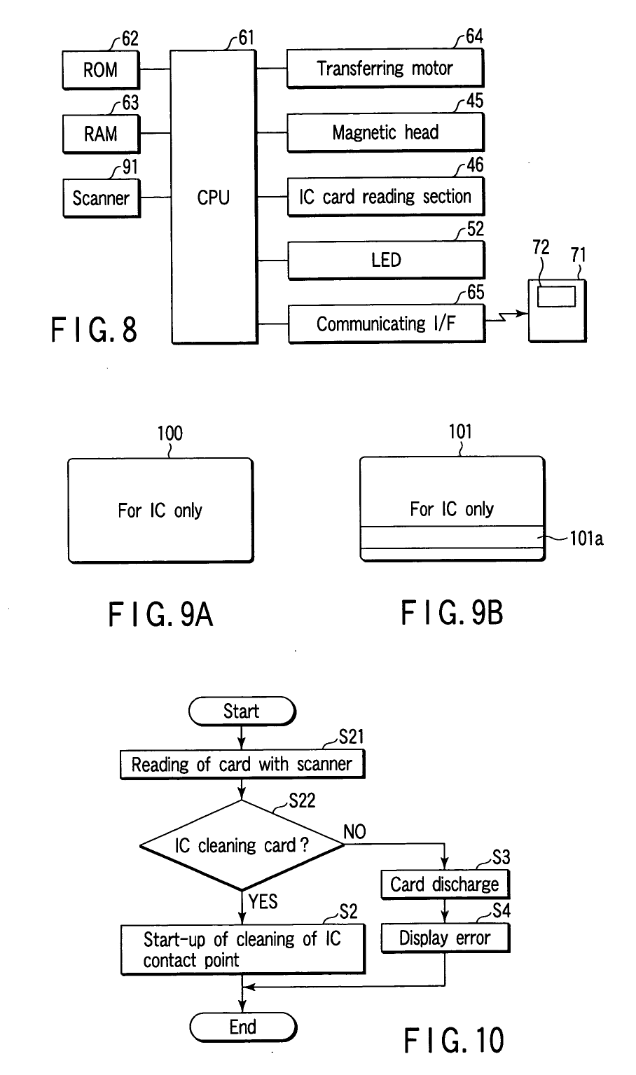

The system construction of the magnetic card reader 10 will now be described with reference to FIG. 8. In FIG. 8, those portions which are equivalent to the portions shown in FIG. 3 are denoted by the same reference numerals so as to omit the detailed description thereof. In FIG. 8, the image data of the card read by the scanner 91 is input to the CPU 61.

The third embodiment of the present invention, which is constructed as described above, will now be described with reference to the flowchart shown in FIG. 10. The operation for cleaning the magnetic head 45 is equivalent to that in the first embodiment of the present invention described previously and, thus, the description thereof is omitted. Where the IC contact point 47 is cleaned, a mode for cleaning the IC contact point 47 is set in the host computer 71. The instruction is transmitted to the magnetic card reader 10. In response to the instruction, the magnetic card reader 10 is operated in the mode of cleaning the IC contact point 47. In other words, the processing for cleaning the IC contact point 47 is performed by the treatments given in the flowchart shown in FIG. 10.

When the operator inserts the cleaning card 100 into the magnetic card reader 10 through the insertion port 41, the cleaning card 100 is transferred in the transfer section 34. While the cleaning card 100 is being transferred, the image of the cleaning card 100 is read by the scanner 91 (step S21). Then, it is judged under control of the CPU 61 whether or not the expression “For IC Only” has been recognized in the image read by the scanner 91 (step S21). Until the result of the judgment is obtained, the cleaning card 100 is held stopped at the position of the magnetic head 45.

Where step S21 yields “YES”, the cleaning of the IC contact point 47 is started (step S2). The processing in step S2 is equivalent to the processing in step S2 described previously. In this fashion, the cleaning of the IC contact point 47 is finished.

On the other hand, where step S21 yields “NO”, it is judged that a card other than the cleaning card 100 has been inserted into the magnetic card reader 10 and, thus, the card inserted into the magnetic card reader 10 is discharged from the magnetic card reader 10 (step S3), and an error is displayed (step S4). The processing in these steps S3 and S4 is equivalent to that described previously.

As described above, in the case of cleaning the IC contact point 47, it is possible to prevent the IC contact point 47 from being broken by cleaning with a cleaning card other than the cleaning card 100 used exclusively for cleaning the IC contact point 47.

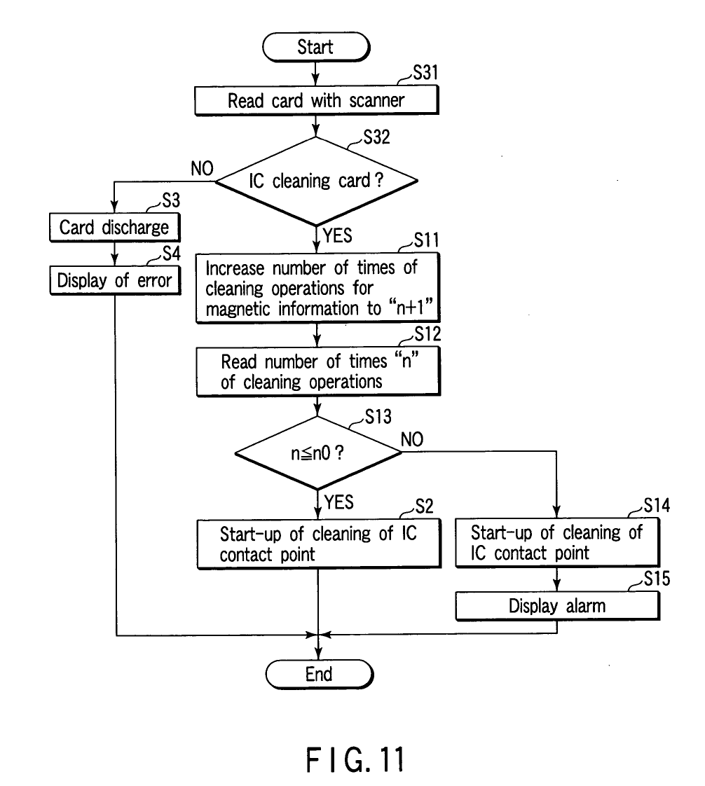

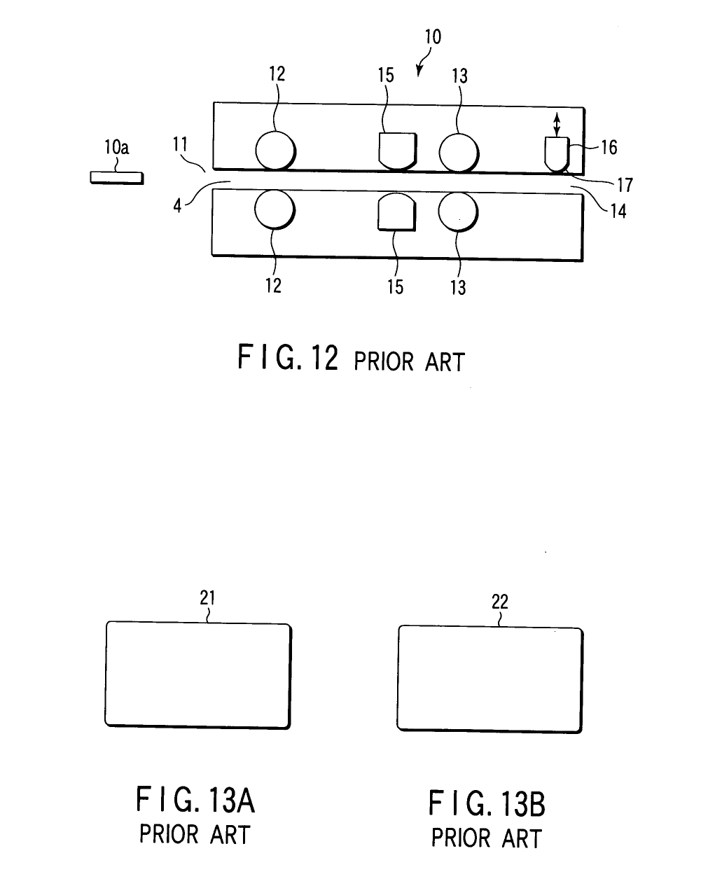

A fourth embodiment of the present invention will now be described with reference to the flowchart shown in FIG. 11. In the fourth embodiment of the present invention, use is made of a cleaning card 101 shown in FIG. 9B, which is used exclusively for cleaning the IC contact point 47. As shown in FIG. 9B, an expression “For IC Only” is printed on the surface of the cleaning card 101. In addition, a magnetic tape 101a is formed on the cleaning card 101.

In the flowchart shown in FIG. 11, those portions which are equivalent to the portions included in the flowchart shown in FIG. 6 are denoted by the same step numbers so as to omit the detailed description thereof. In the fourth embodiment of the present invention, it is judged on the basis of the image data read by the scanner 91 whether or not the cleaning card inserted into the magnetic card reader 10 is the cleaning card 101 used exclusively for cleaning the IC contact point 47.

In the case of cleaning the IC contact point 47, a mode for cleaning the IC contact point 47 is set in the host computer 71. The instruction is transmitted to the magnetic card reader 10. In response to the instruction, the magnetic card reader 10 is operated in the mode of cleaning the IC contact point 47. In other words, the processing for cleaning the IC contact point 47 is performed by the processing given in the flowchart shown in FIG. 11.

When the operator inserts the cleaning card 101 into the magnetic card reader 10 through the insertion port 41, the cleaning card 101 is transferred in the transfer section 34. While the cleaning card 101 is being transferred, the image of the cleaning card 101 is read by the scanner 91 (step S31). Then, it is judged under control of the CPU 61 whether or not the expression “For IC Only” is recognized from the image read by the scanner 91 (step S32). Until the result of the judgment is obtained, the cleaning card 101 is held stopped at the position of the magnetic head 45.

Where step S32 yields “YES”, the processing proceeds to step S11. The processing in step S11 and thereafter is equivalent to that described previously with reference to FIG. 6 and, thus, the detailed description thereof is omitted.

As described above, in the case of cleaning the IC contact point 47, it is possible to prevent the IC contact point 47 from being broken by cleaning with a cleaning card other than the cleaning card 101 used exclusively for cleaning the IC contact point 47. Further, it is possible for the operator to know the replacement time of the cleaning card 101.

In each of the third and fourth embodiments of the present invention described above, it is judged by using the scanner 91 whether or not the cleaning card inserted into the magnetic card reader 10 is the cleaning card used exclusively for cleaning the IC card. Alternatively, it is also possible to use an optical character reader in place of the scanner 91. Further, it is possible to print a barcode representing “For IC Only” on the surface of the cleaning card. In this case, it suffices to mount a reflection-type sensor in the transfer section 34.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A reader for IC mounted magnetic card, comprising:
a transfer section constructed to transfer a magnetic card or an IC card inserted into the reader for an IC mounted magnetic card through an insertion port;
a magnetic head for reading the magnetic information recorded on the magnetic card;
an IC card reading section constructed to be brought into contact with an IC contact point of the IC card so as to read data recorded in the IC; and
judging means for judging the kind of card as to whether the inserted card is a cleaning card for cleaning the IC card contact point.

2. A reader for IC mounted magnetic card, comprising:
a transfer section constructed to transfer a magnetic card or an IC card;
a magnetic head for reading the magnetic information recorded on the magnetic card;
an IC card reading section constructed to be brought into contact with the IC contact point of the IC card so as to read the data recorded in the IC;
a cleaning card for cleaning an IC contact point of the IC card, said cleaning card being a cleaning card used exclusively for cleaning the IC card and including a magnetic tape storing a discriminator indicating that the inserted cleaning card is a cleaning card for cleaning at least the IC contact point of the IC card; and
judging means judging, based on the magnetic information read by the magnetic head, that the inserted cleaning card is a cleaning card for cleaning the IC contact point of the IC card.

3. The reader for IC mounted magnetic card according to claim 2, further comprising:
a cleaning section constructed to clean the IC contact point of the IC card,
wherein the IC contact point of the IC card is cleaned by the cleaning section when it is judged by the judging means that the inserted cleaning card is a cleaning card for cleaning the IC contact point of the IC card.

4. The reader for IC mounted magnetic card according to claim 2, wherein the kind of the card is judged by the judging means before the card is transferred in the transfer section to reach an IC card reading section.

5. The reader for IC mounted magnetic card according to claim 2, wherein, where the card is judged to be an erroneous card by the judging means, the card is brought back to the insertion port before the card is transferred in the transfer section to reach an IC card reading section.

6. The reader for IC mounted magnetic card according to claim 2, wherein, where the card is judged by the judging means to be a cleaning card for cleaning the IC card contact point, the IC contact point of the IC card reading section is moved downward.

7. The reader for IC mounted magnetic card according to claim 2, wherein the number of times of cleaning operations applied to the IC contact point is stored on the magnetic tape of the cleaning card used exclusively for cleaning the IC card.

8. The reader for IC mounted magnetic card according to claim 6, wherein the number of cleaning operations applied to the IC contact point is stored on the magnetic tape of the cleaning card used exclusively for cleaning the IC card and, where it is judged by the judging means that the inserted cleaning card is a cleaning card for cleaning the IC card contact point and where the number of cleaning operations applied to the IC contact point is not larger than a specified number, the IC contact point of the IC card reading section is moved downward.

9. The reader for IC mounted magnetic card according to claim 7, further comprising an alarm section,
and wherein the alarm section is driven in the case where the number of cleaning operations applied to the IC contact point is not smaller than a specified number.

10. The reader for IC mounted magnetic card according to claim 2, wherein the judging means judges the kind of the card based on the result of the detection achieved by a scanner, an optical character reader or a reflection-type sensor.

11. A reader for IC mounted magnetic card, comprising:
a scanner section;
a transfer section constructed to transfer a magnetic card or an IC card;
a magnetic head for reading the magnetic information recorded on the magnetic card;
an IC card reading section constructed to be brought into contact with the IC contact point of the IC card so as to read data recorded in the IC;
a cleaning card used exclusively for cleaning the IC card and including a magnetic tape; and
judging means for judging based on the result of detection of the scanner section that the inserted card is a cleaning card for cleaning the IC contact point of the IC card.

12. The reader for IC mounted magnetic card according to claim 11, wherein the number of times of cleaning operations applied to the IC contact point is stored on the magnetic tape of the cleaning card used exclusively for cleaning the IC card.

13. The reader for IC mounted magnetic card according to claim 12, further comprising an alarm section,
and wherein the alarm section is driven in the case where the number of cleaning operations applied to the IC contact point is not smaller than a specified number.
